(19) United States
(12) Patent Application Publication
(10) Pub. No.: US 2008/0099962 A1
(43) Pub. Date: May 1, 2008

(54) Method and device for controlling the quality of thermoplastic molding compositions

(76) Inventors: Bahman Sarabi, Krefeld (DE); Jens Stange, Krefeld (DE); Klaus Salewski, Krefeld (DE); Christof Halas, Rheinberg (DE); Alexander Karbach, Krefeld (DE)

Correspondence Address: BAYER MATERIAL SCIENCE LLC, 100 BAYER ROAD, PITTSBURGH, PA, 15205, US

(21) Appl. No.: 11/977,575

(22) Filed: Oct. 25, 2007

(30) Foreign Application Priority Data
Oct. 31, 2006 (DE) 102006059321.9
Oct. 31, 2006 (DE) 102006051309.6
Oct. 31, 2006 (DE) 102006051308.8
Oct. 31, 2006 (DE) 102006051306.1
Oct. 31, 2006 (DE) 102006051305.3

(51) Int. Cl. G01B 11/00

(52) U.S. Cl. 264/408; 425/173

(57) ABSTRACT

A method for controlling the quality of thermoplastic molding compositions in granular form is disclosed. The method entails obtaining a sample from a batch of granules, producing at least one transparent plastics article from the sample, examining the article for visible defects and determining, on the basis of the examination whether said article meets at least one predetermined quality acceptance criterion. Also disclosed is a device for carrying out the inventive method.

### FIELD OF THE INVENTION

The invention relates to a method for controlling the quality of thermoplastic molding compositions in granular form and to a device for controlling the same.

### BACKGROUND OF THE INVENTION

Plastics articles are often produced from polymeric compositions in granular form, for example by an injection-molding process. Plastics articles are objects of everyday life and are produced in many different forms and for a variety of uses. For example, optical data storage means such as CDs, DVDs, etc. consist largely of plastics materials. Countless plastics materials are also used in motor vehicle manufacture. An example which may be mentioned in this connection is the lining of motor vehicle headlamps, which is visible from the outside. Such linings are transparent to the light produced in the headlamp. Likewise, the above-mentioned plastics materials which are used for CDs, for example as carrier material, are transparent to the light used for reading the CDs.

Defects in the plastics materials mean that the plastics materials in some cases can no longer be employed for their originally intended use. For example, defects in a plastics article used as the substrate material for a CD or DVD can lead to erroneous reading of the stored data. The demands made of plastics materials used as the substrate material for CDs, DVDs, etc. are increasing further because the storage density of the medium in question is increasing further, and even relatively small faults can accordingly have an adverse effect on reading accuracy.

Defects that occur in the plastics article arise on the one hand as a result of the production process and on the other hand because such defects are already present in the plastics granules from which the plastics articles are produced. DE 198 20 948 describes a method for the quality control of plastics granules. In that method, a sample of plastics granules is diverted from a main stream of plastics granules. A film is produced continuously from the diverted plastics granules and is fed to a measuring chamber which is irradiated with infra-red light. An infra-red absorption spectrum in transmission of sections of the film located in the measuring chamber is also recorded continuously. The infra-red absorption spectra so obtained are evaluated in order to determine material properties of the plastics granules. Defects that exhibit absorption in the UV range or in the visible range are relevant for plastics articles used as the substrate material for CDs. Such defects are difficult to detect by means of IR absorption spectroscopy. The object of the invention is, therefore, to provide an improved method for the quality control of plastics granules. It is a further object of the invention to provide an improved device for the quality control of a batch of granules.

### BRIEF DESCRIPTION OF THE DRAWINGS

FIG. 1 is a block diagram of a device for controlling the quality of a batch of granules.

FIG. 2 is a flow diagram showing steps of a method according to the invention.

FIG. 3 is a perspective view of a plastics article.

FIG. 4 is an example of a table detailing the type, size and shape of defects.

FIG. 5 is a flow diagram of steps of the inventive testing method.

FIG. 6 shows a perspective view of a plastics article examined by the inventive method.

FIG. 7 is a block diagram of a computer system.

### SUMMARY OF THE INVENTION

A method for controlling the quality of thermoplastic molding compositions in granular form is disclosed. The method entails obtaining a sample from a batch of granules, producing at least one transparent plastics article from the sample, examining optically the article for defects and determining, on the basis of the examination whether said article meets at least one predetermined quality acceptance criterion. Also disclosed is a device for carrying out the inventive method.

### DETAILED DESCRIPTION OF THE INVENTION

According to the invention, a method and a device for controlling the quality of a batch of granules is provided. According to the method, a sample is taken from the batch of granules and at least one transparent plastics article is produced from the sample. In a further step, the at least one transparent plastics article is checked for defects by means of an optical testing method. On the basis of the defects it is then determined whether the at least one plastics article meets at least one predetermined quality acceptance criterion. Furthermore, the batch of granules is released for full scale production if the at least one article meets the quality acceptance criterion.

Defects that are already present in the granules may be the cause of defects in the plastics articles produced from the granules. According to the invention, quality control of the batch of granules is carried out by producing at least one plastics article from the sample taken from the granules. The granules are only released for full scale production if it has been determined, on the basis of examining the defects in the plastics article, whether the article meets the predetermined quality acceptance criterion. The plastics article accordingly serves as a test specimen, which is produced from the granules. If the granules are intended for the production of CD substrates, for example, the required quality criteria for CD substrates are applied to the test specimen. Only if the test specimen meets those quality criteria is it accepted that the granules are suitable for the production of CD substrates therefrom. In a corresponding manner, a different predetermined quality acceptance criterion is applied to the test specimen if motor vehicle headlamp covers, for example, are to be produced therefrom, because less stringent quality criteria may be applied in this case.

The method has the advantage that, by producing one or more articles serving as test pieces, the quality of the granules used for the production of the plastics articles is determined in respect to optically detected defects. It is thereby possible to determine whether the granules are suitable at all as the raw material for the intended plastics articles, even before the granules are delivered to a customer or before the granules are used in mass production to produce the plastics articles. Unsuitable granules are not used at all for the production of plastics articles or delivered to customers. As a result, the amount of unusable plastics articles eliminated as rejects is reduced, which leads to a reduction in production costs. In addition, complaints from customers will be less frequent, because only high-quality granules are supplied, which naturally results in an improvement in the image of the granule manufacturer with his customers.

According to an embodiment of the invention, the at least one transparent plastics article is produced from the sample by injection-molding. Producing the at least one transparent plastics article by injection-molding has the advantage that a transparent plastics article is thereby produced in the same manner as plastics articles are generally also produced on an industrial scale. A test piece is thereby produced which, because it has been produced in the same way as in mass production, contains similar production-related defects. A test piece so produced is accordingly particularly suitable for use in determining whether the granules used for the test piece meet the predetermined quality acceptance criterion.

According to an embodiment of the invention, the at least one plastics article is in plate or sheet form. On the one hand, a plastics article in plate or sheet form is particularly simple to produce in an injection-molding machine, and on the other hand plastics articles in plate or sheet form may be tested particularly successfully by means of optical testing methods. Furthermore, defects in the plastics article form mainly as a result of the molding process in the injection-molding machine, in particular through contact of the molten resin with the surface of the mold. The geometry of the mold is secondary. Minute particles such as gel particles, for example, that cause the defects are already present in the granules. The use of plastics plates as a particular embodiment of an injection-molding tool geometry for determining whether granules fulfil a given quality criterion is therefore wholly sufficient.

According to an embodiment of the invention, deionizing air is blown onto at least one surface of the at least one plastics article before it is checked for defects. The at least one surface is discharged electrically by the deionizing air. Dust particles are removed from the at least one surface. In addition, the discharged surface features less attraction to dust particles. This has the advantage that far fewer dust particles are present on the surface when the plastics article is checked for defects by means of the optical testing method. A further advantage of the use of deionizing air is that the production and checking of the plastics article do not have to be carried out in a clean room. This makes the quality control method less expensive to carry out.

According to an embodiment of the invention, at least one plastics molding is produced in the injection-molding machine by means of a film gate after prior screw plasticization of the granules. Screw plasticization of the granules is carried out with injection-molding screws cut to promote flow. The injection-molding screws and injection-molding cylinders have deposit-resistant surface coatings and/or consist of high-chrome alloys. In a particular embodiment, the injection-molding machine is equipped with an on-line data acquisition system. The data acquisition system ensures that the melt and tool temperatures are in a suitable temperature range for the material. Furthermore, thermal decomposition and/or crosslinking processes, which may cause defects, are avoided. The further process parameters that are relevant therefore also include the cycle time, which determines the dwell time of the plastics material in the machine, and pressures counteracting possible cavitation, which are likewise ensured by the data acquisition system, as well as the rate of injection, which is critical for the shear rate that occurs and accordingly for the resulting shear stress on the melt. The injection molding is done by off-centre gating via a straight cold runner with a film gating system. Off-centre gating is advantageous to avoid flow deviations and the material deposits promoted thereby in the region of the flow deviations.

After production and after removal of the sprue, the plastics plate passes through a cooling line, which results in homogeneous cooling of the test piece. After cooling of the injection-molded plate, it is removed by a suitable gripper system without contact with the surface of the plate. A preferred embodiment of a gripper system is a lateral gripper which touches only the edges of the plate.

According to an embodiment of the invention, the optical testing method comprises the step of exposing the at least one plastics article to light produced by a first light source. The light is preferably in a wavelength range from 10 to 500 nm. The optical testing method further comprises the step of detecting fluorescent light, the fluorescent light being produced by fluorescing defects in the plastics article due to their exposure to the light.

According to the invention, therefore, each plastics article is exposed to light. Defects in the plastics article fluoresce by absorbing the light and re-emitting the light in a different wavelength range, as a result of which the fluorescing defects may be detected. The advantage of this testing method is that fluorescing defects in the plastics article may be detected in a particularly simple manner, because it is in principle necessary simply to record, for example by means of a camera, the plastics article illuminated with the light and then identify the fluorescing defects in the plastics article in the recorded picture, for example by means of an image processing program.

According to an embodiment of the invention, a surface of the at least one plastics article is exposed to light, a projected area of the fluorescing defects being determined. For this purpose, the light emitted from the plastics article is detected by cameras. By means of an image processing software the detected light is analyzed and the projected area of each fluorescing defect as well as the total projected area of all fluorescing defects can be determined. The quality acceptance criterion may then specify a maximum permitted total projected area of all fluorescing defects in relation of the size of the examined surface of the plastic article (e.g.: maximum permitted total projected area of all fluorescing defects is equal to 10% of the examined surface of the plastic article), whereas an acceptance of the batch of granules takes place only if the total projected area of all fluorescing defects is smaller than the maximum permitted total projected area. The advantage is that only the total projected area of the fluorescing defects, not the projected areas of the individual fluorescing defects, is used to determine whether the plastics article meets the quality criterion. The total projected area is far simpler to determine than, for example, the projected area of each individual defect.

According to an additional embodiment of the invention, the optical testing method further comprises the step of comparing the size and/or shape of each fluorescing defect. The number of fluorescing defects in each plastics article checked by means of the optical testing method is also compared. Comparing the size and/or shape of each fluorescing defect has the advantage that each defect may be recognized as such. A fluorescing dust particle, which is generally larger and also has a different shape than fluorescing defects in the plastics article, is accordingly not falsely detected as a defect. Accordingly, in the most disadvantageous case, the corresponding plastics article is not categorized as failing to meet the given quality criterion owing to fluorescing dust particles. Furthermore, the number of fluorescing defects in each plastics article may be used directly as a quality criterion. If, for example, the number of fluorescing defects in a plastics article exceeds a given maximum permissible number, then the plastics article may correspondingly be categorized as failing to meet the given quality criterion.

According to an embodiment of the invention, localization of the fluorescing defects in each plastics article checked by means of the optical method is also carried out. By means of the localization it is possible, for example, to decide whether the fluorescent light is coming directly from a fluorescing defect or whether fluorescent light from a dust particle has been detected by mistake.

According to an embodiment of the invention, the method may further comprise the step of image processing of the detected fluorescent light. A determination of fluorescing defects and of dust particles is also carried out, the dust particles fluorescing when exposed to light and the dust particles being distinguishable from the fluorescing defects on the basis of shape and/or size and/or position and/or wavelength and/or the colour of the fluorescent light emitted by the dust particles, and the dust particles not being included in the determination of whether the at least one plastics article fulfils the at least one given quality criterion.

According to an embodiment of the invention, the light source emits light in the blue wavelength range and/or in the ultraviolet wavelength range and the fluorescing defects emit light in the visible range, the fluorescent light being detected and the light emitted by the light source being blocked by means of a filter arranged in front of the detector for detecting the fluorescent light. The fluorescent light may thus be detected in a particularly simple manner. The fluorescing defects are generally gel particles. The gel particles are generally already present in the granules. Accordingly, the invention provides a simple method for controlling the quality of the batch of granules in particular in respect of gel articles in the granules. Gel particles in the granules may lead to flow disturbances, known also as streaks, in the finished injection-molded part, that is to say in the plastics article. Streaks are particularly undesirable in plastics articles because they are elongated, relatively large defects.

According to an embodiment of the invention, the optical testing method is a combination of the optical testing method described above and a beamed-line method, or alternatively it is only a beamed-line method. Beamed-line methods for detecting defects are described, for example, in DE 101 44 909 or DE 10 2004 054 102 A1. In beamed-line methods, a plastics article is exposed to white light. Defects in the plastics article may be detected by a spatially resolved measurement of the intensity of the reflected and transmitted scattered light. By means of beamed-line technology, optical faults of very small dimensions in the region of a few micrometres (streaks, pinholes) and also opaque, light-scattering faults (glass fibres, air inclusions) may be detected. Dust on the surface of the plastics article may also be detected thereby.

Non-fluorescing defects in particular may be detected thereby. By using a combination of the testing method described above and the beamed-line method it is possible in a particularly simple manner to detect fluorescing defects, that is to say gel particles in particular, which may be detected further in respect of streaks by means of the beamed-line method. The testing of a plastics article for defects by means of the above-described combination may also take place in a plurality of steps. First, for example, the fluorescing defects may be detected by means of a first light source/camera system. Thereafter, the non-fluorescing defects may be detected by means of the beamed-line method using one or more further light source/camera systems.

According to an embodiment of the invention, the method further comprises the step of categorizing the batch of granules into one of several quality classes, at least one quality criterion being specified for each quality class and the batch of granules being released for the highest quality class of the several quality classes for which the at least one plastics article still meets the corresponding quality criterion.

For example, a quality class may relate to granules for the production of CD or DVD substrates. Very high demands in terms of quality would be made of the at least one plastics article produced from a sample of the corresponding granules. If the plastics article does not meet the given quality criterion, then the corresponding batch of granules is not released for the production of CD or DVD substrates. The plastics article may, however, meet the quality criteria set, for example, for a motor vehicle headlamp cover. In this case, the granules would then be released for that use. Categorization of the batch of granules therefore has the advantage that the granules to be tested may be divided into several quality classes and then supplied to a customer whose demands on the granules, in terms of quality, correspond to that quality class.

In another aspect, the invention relates to a device for controlling the quality of a batch of granules. The device has means for producing at least one transparent plastics article from a sample, the sample being taken from the batch of granules. The device further has means for analyzing the at least one transparent plastics article for defects by means of an optical testing method. The device further has means for determining, on the basis of the defects, whether the at least one plastics article meets at least one predetermined quality acceptance criterion. The device may additionally have means for releasing the batch of granules in the instances where at least one predetermined quality acceptance criterion is met by the at least one plastics article.

Preferred embodiments of the invention are described in greater detail hereinbelow with reference to the drawings, in which:

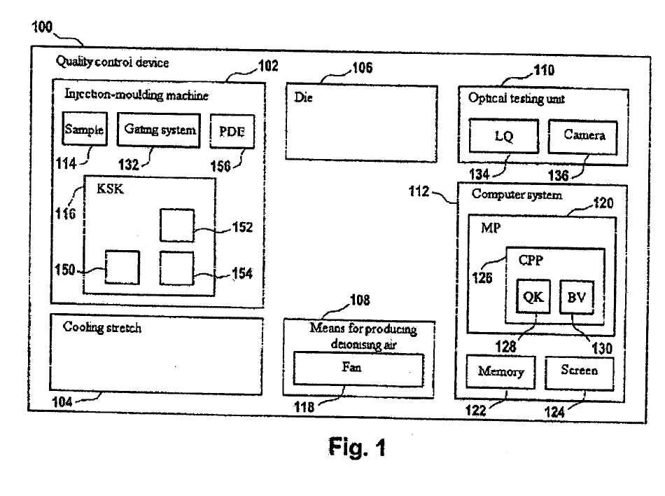

FIG. 1 shows a block diagram of a device for controlling the quality of a batch of granules,

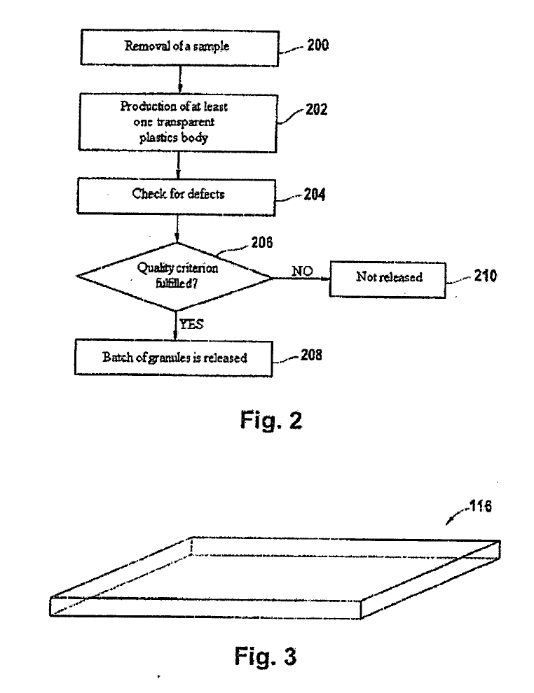

FIG. 2 shows a flow diagram showing important steps of a method according to the invention,

FIG. 3 shows a perspective view of a plastics article,

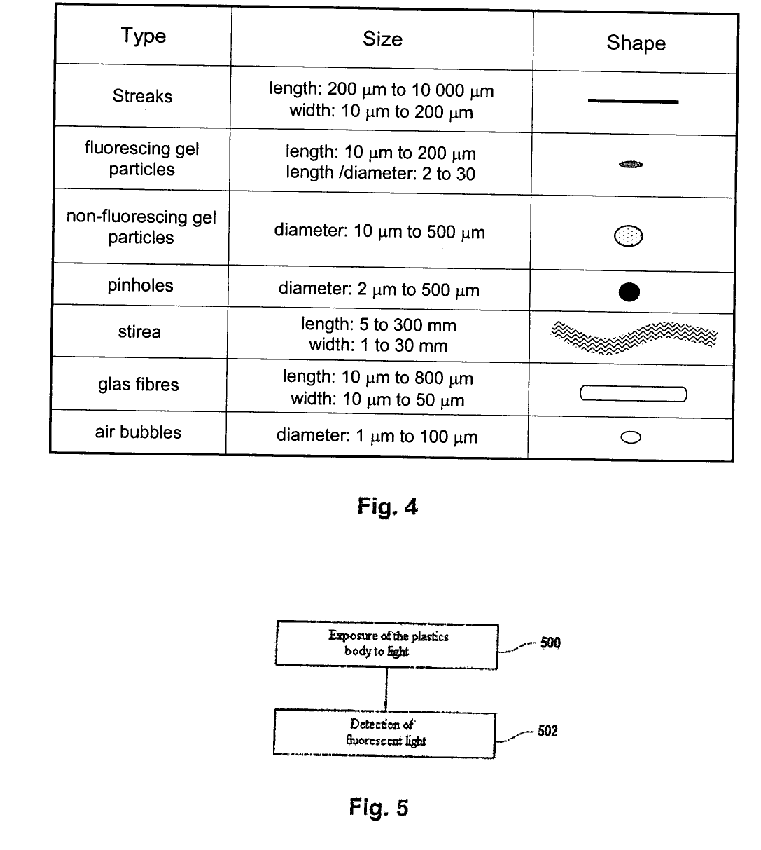

FIG. 4 shows a table in which the type, size and shape of defects in a plastics article are specified in greater detail,

FIG. 5 shows a flow diagram in which important steps of an optical testing method according to the invention are shown,

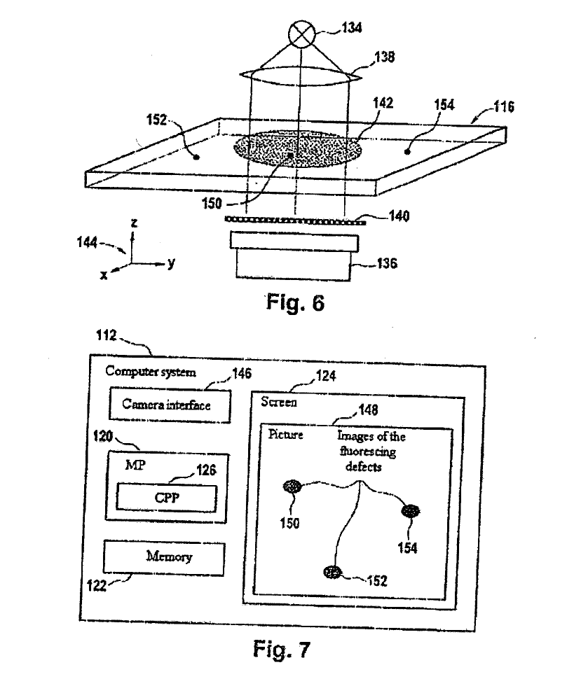

FIG. 6 shows a perspective view of a plastics article that is being checked for defects by means of the optical method according to the invention,

FIG. 7 shows a block diagram of a computer system.

FIG. 1 shows a block diagram of a device 100 for controlling the quality of a batch of granules. The device 100 has an injection-molding machine 102, a cooling stretch 104 and a die 106. The device 100 for quality control also has means 108 for producing deionizing air, and an optical testing unit 110. The device 100 also has a computer system 112.

A sample 114 is taken from a batch of granules that is being subjected to quality control according to the invention and is fed to the injection-molding machine 102, in order to produce a plastics article (KSK) 116 from the sample 114. The injection-molding machine 102 has a film gating system 132 and an on-line data acquisition system (PDE) 156.

The data acquisition system 156 ensures that the melt and tool temperatures are in a suitable temperature range for the material. Thermal decomposition or crosslinking processes, for example, which may lead to additional defects, are thereby avoided. The further process parameters relevant therefor also include the cycle time, which determines the dwell time in the machine, and pressures counteracting possible cavitation, which are likewise ensured by the data acquisition system 156, as well as the rate of injection, which has a controlling influence on the shear rate and accordingly on the shear stress on the material.

The film gating system 132 serves to receive the melted sample 114 and guide it into a tool cavity of the injection-molding machine 102. on the Injection-molding of the plastics article 116 produced from the sample 114 by means of the injection-molding machine is done by off-centre gating via a straight cold runner in order to avoid flow deviations and the material deposits promoted thereby in the region of the flow deviations. The tool cavity is formed by at least two mold halves, by means of which the plastics article is produced with wall thicknesses of from 0.5 to 10 mm, preferably from 1 to 4 mm, and with a flow length of from 50 to 700 mm, preferably from 100 to 300 mm.

The plastics article 116 is removed from the injection-molding machine 102, for example with a handling device, without the surfaces of the plastics article 116 being damaged. By means of the (automated) die 106, the sprue is separated from the plastics article 116. The plastics article 116 then passes through the cooling stretch 104, whereby the plastics article 116 is cooled.

Before the plastics article 116 is conveyed to the optical testing unit 110, deionizing air is blown onto at least one surface side of the plastics article 116. To this end, the means 108 for producing deionizing air has a fan 118. The surface side of the plastics article 116 onto which air is to be blown is conveyed past the fan 118, dust particles being removed from the surface and the surface being discharged. As a result, no more new dust particles are attracted, or at least new dust particles are attracted to a far lesser degree than previously.

The plastics article is then conveyed to the optical testing unit 110. The optical testing unit 110 has a light source 134 and a camera 136. The light source 134 produces light in the blue or in the ultraviolet wavelength range.

When the plastics article is exposed to the light from the light source, defects such as, for example, the defects 150, 152 and 154 fluoresce, in so far as such defects are present and are able to fluoresce. The fluorescing defects 150, 152, 154 are in particular gel particles, which are generally already present in the granules. The gel particles occur as defects per se in the plastics particle. They can, however, also cause long flow disturbances, so-called streaks. Streaks always extend approximately directly (+/−15°) in the flow direction of the sprue in the injection-molding machine 102. Streaks form when a gel particle is drawn along over a certain distance in the flow direction during casting of the plastics article. Streaks therefore always contain a gel particle. Dust particles also fluoresce on exposure to the light from the light source 134. The number of dust particles should, however, be minimal owing to the use of deionizing air.

The camera 136 is used to detect the fluorescent light. The fluorescent light is shifted into the longer wavelength range in relation to the light emitted by the light source 134. It is therefore advantageous to position a filter in front of the camera, the filter having low transmittivity of 0% to 20%, preferably of 0% to 10% to the light from the light source 134 and high transmittivity of 25% to 100%, preferably of 80% to 95% to the fluorescent light. It may thus be ensured, in a simple manner, that the camera detects only the fluorescent light and not the light from the light source 134.

The camera 136 accordingly serves to record an image of the plastics article 116 with fluorescing defects. The camera signal may be evaluated by means of the computer system 112. The computer system 112 has a microprocessor 120, a memory 122 and a screen 124. The picture recorded using the camera 136, for example, may be displayed to operating staff on the screen 124.

The microprocessor 120 executes a computer program product 126, which is stored permanently in the memory 122 and has been read out by the microprocessor 120.

The computer program product 126 has an image processing component 130. By means of the image processing component 130, the fluorescing defects 150, 152, 154 in the plastics article 116, or in the image of the plastics article obtained with the camera 136, may be detected. For example, the size and shape of each fluorescing defect may be determined with the image processing component 130. The image processing component 130 also allows the number of fluorescing defects in the plastics article 116 to be determined.

A quality acceptance criterion 128 is also integrated in the computer program product 126. The computer program product 126 determines, on the basis of the fluorescing defects found via the image processing component 130, whether the plastics article 116 meets the quality acceptance criterion 128.

The predetermined quality acceptance criterion 128 can, for example, specify that no fluorescing defects having a size (projected area) greater than 100 μm² may be present in the plastics article. In the case where a defect larger than 100 μm² is detected by means of the image processing component 130, the batch of granules will not be released. This may be effected by the computer program product 126 emitting, via the screen 124, a corresponding message to the operating staff. If no defect larger than 100 μm² is found, the batch of granules is released in accordance with the invention, which may be effected, for example, by the computer program product 126 emitting a corresponding message to the operating staff.

Alternatively to or in combination with the above-described optical testing method, other, non-fluorescing defects, such as, for example, streaks, pinholes and glass fibres, may also be detected in accordance with the invention in the optical testing unit 110 by means of the beamed-line method. To this end, the optical testing unit also has further light source/camera systems (not shown in FIG. 1), the light sources in this case emitting white light and the intensities of the reflected or transmitted scattered light being detected by the cameras. The size, position and shape of a detected non-fluorescing defect may then be determined from the intensity distributions of the reflected or transmitted light, as described in DE 10 2004 054 102 A1 or DE 101 44 909.

The use of the above-mentioned method, in which gel particles are detected via their fluorescent light, in combination with the beamed-line method has the advantage that the gel particles may first be detected in a simple manner. The more complex beamed-line method may then be used to detect the streaks caused by the gel particles, from which information may then be obtained, for example, about the formation of streaks. The non-fluorescing defects, such as, for example, pinholes, air inclusions and glass fibres, may also be detected by the beamed-line method, so that the granules may be classified further by means of further quality criteria that do not relate to the non-fluorescing defects. It is accordingly possible, as described in detail above for the fluorescing defects, to apply to the defects found by means of the beamed-line method quality criteria which may be used, on their own or in combination with the quality criteria for the fluorescing defects, to classify the granule sample into a quality class.

FIG. 2 shows a flow diagram which shows important steps of the method according to the invention. In step 200, a sample is taken from a batch of granules. In step 202, a transparent plastics article is produced from the sample. In step 204, the transparent plastics article is checked for defects by means of an optical testing method. In step 206, it is determined, on the basis of the defects, whether the plastics article fulfils a given quality criterion. If that is the case, the batch of granules is released in step 208, for example for use in the production of plastics articles that must fulfil the above-mentioned quality criterion. If it was determined in step 206 that the plastics article does not fulfil the quality criterion, the granule quality is categorised in step 210 as being inadequate for the quality criterion.

FIG. 3 shows a perspective view of the plastics article 116. The plastics article 116 is in plate form. The wall thickness of the plastics article 116 is, for example, from 1 to 4 mm and the length or width is in a range from 50 to 300 mm. The plastics article is transparent to the light used in the optical testing method and to the fluorescent light.

FIG. 4 shows a table in which defects occurring in the plastics article are classified. As already mentioned above, streaks are flow disturbances caused when a gel article is drawn along over a certain distance in the flow direction during casting of the plastics plate in the injection-molding article. Streaks therefore always contain a gel particle and are oriented longitudinally in the flow direction. The width of the streaks varies from 10 to 200 μm. The length of the streaks in the flow direction is generally from 0.2 to 10 mm.

Gel particles are inclusions of gel-like material, which has different optical properties than the plastics article. There are fluorescing and none-fluorescing gel particles. Fluorescing gel particles fluoresce on irradiation with UV light or with light in the blue wavelength range. The length of the fluorescing gel particles is approximately from 10 to 200 μm The none-fluorescing gel particles possess a cross-sectional area which is oval or circular in shape. The diameter of the none-fluorescing gel particles is between 10 to 500 μm and mainly between 30 to 300 μm.

Pinholes or black spaces are spherical, macroscopic optical (none-transparent) defects, either consisting of foreign material like metals, pigments or a different polymeric material or are caused by overheating of the plastics material, for example during production of the granules. Pinholes have a diameter from 2 to 500 μm and mainly from 5 to 300 μm. Agglomerations of pinholes can cause foggy defects (striae) with length of 5 to 100 mm, mainly 10 to 30 mm and width of 1 to 30 mm, mainly of 2 tp 15 mm.

Glass fibres and air bubbles may also occur in the plastics article, but they are substantially less relevant than the defects mentioned above. Glass fibers have a cylindrical shape with length of 10 to 800 μm, mainly of 30 to 500 μm and diameter of 10 to 50 μm, mainly of 10 to 20 μm. Air bubbles are oval in shape and have a diameter of 1 to 100 μm, mainly of 2 to 30 μm.

FIG. 5 shows a flow diagram of an optical testing method according to the invention. In step 500, the plastics article is exposed to light produced by a light source. In step 502, fluorescent light is detected, the fluorescent light being produced by fluorescing defects in the plastics article when the corresponding defects are exposed to the light.

FIG. 6 shows, in diagrammatic form, a perspective view of the plastics article 116 in the optical testing unit 110. The optical testing unit 110 has, as mentioned above, the light source 134 and the camera 136. The optical testing unit 110 additionally has a lens 138 and a filter 140.

The light source 134 is, for example, a mercury vapor lamp or a blue laser. The light from the light source 134 is guided via the lens 138, so that an area 142 of the plastics article 116 is exposed to the light. The light penetrates the plastics article 116 in the area 142. Defects suitable for fluorescence (in this case the defect 150) fluoresce in the area 142. The camera 136 with the filter 140 is located on the opposite side of the light source 134 in relation to the plastics article 116. The filter 140 has high transmittivity of 25% to 100%, preferably of 80% to 95% to the fluorescent light and low transmittivity of 0% to 20%, preferably of 0% to 10% to the light emitted by the light source. The fluorescing defects may therefore be detected by the camera 136 without interference from the light emitted by the light source 134.

For recording of the fluorescing defects, the plastics article 116 is moved between the light source 134 and the camera 136 in the y-direction according to the coordinate system 144. The light source 134, or the camera 136, is thereby displaceable in the x-direction according to the coordinate system 144, so that the area 142 ultimately migrates over the entire plastics article 116 and an image of the whole of the plastics article 116 may be recorded by the camera 136. The image may be fed to the image processing component 130 (see FIG. 1).

FIG. 7 shows a block diagram of the computer system 112. As already mentioned before, the computer system 112 has the microprocessor 120, the memory 122 and the screen 124. The microprocessor 120 executes the computer program product 126. The computer system 112 also has a camera interface 146, with which the picture of the plastics article 116 recorded by the camera 136 may be transferred to the computer system 112. The screen 124 displays the picture 148 of the plastics article 116. The defects 150, 152 and 154 are shown in the picture 148. The individual areas 142 (see FIG. 6) have been combined by the computer program product 126 to form the picture 148 of the plastics article 116.

The picture 148 corresponds to a projection of the plastics article along the xy-plane (see coordinate system 144 in FIG. 6), because the light illuminates the plastics article in relation to the xy-plane and, as it were, the shading is imaged by the camera. The fluorescing defects 150, 152 and 154 shown in the picture 148 likewise correspond to projections of the defects present in the plastics article in the xy-plane. The fluorescing defects are shown as bright points owing to their fluorescence (in FIG. 6 they are shown as dark points for the sake of simplicity). Owing to the light/dark distribution in the picture 148; the defects 150, 152 and 154 may therefore be localised and their size and shape may be determined. In addition, the number of defects in the solid article may be determined.

The given quality criterion can, for example, require that the total area occupied by the fluorescent defects 150, 152 and 154 in relation to the total area of the picture 148 must not exceed a given value. This means that the total projected area of the defects 150, 152, 154 must be smaller than a given fraction of the projected area of the plastics article. If that is not the case, the quality of the granules is categorized as inadequate.

Further quality criteria on the basis of which the plastics article, or the granules, is/are assessed are also suitable, including the size, position, number and/or shape of the defects. The quality criteria may in each case be applied individually or in combination with one another.

### LIST OF REFERENCE NUMERALS

100 device
102 injection-molding machine
104 cooling stretch
106 die
108 means for producing deionizing air
110 optical testing unit
112 computer system
114 sample
116 plastics article
118 fan
120 microprocessor
122 memory
124 screen
126 computer program product
128 quality criterion
130 image processing component
132 gating system
134 light source
136 camera
138 lens
140 filter
142 area
144 coordinate system
146 camera interface
148 image of the plastics article
150 defect
152 defect
154 defect
156 data acquisition system

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A method for controlling the quality of a thermoplastic molding composition in granular form, comprising
(i) obtaining a sample from a batch of granules, and
(ii) producing from the sample at least one transparent plastics article, and
(iii) examining optically the at least one transparent article to detect for defects
and (iv) determining, on the basis of said examining whether said article meets at least one predetermined quality acceptance criterion.

2. The method according to claim 1, wherein said producing is injection-molding.

3. The method according to claim 1 wherein the article is in sheet or plate form.

4. The method according to claim 1 wherein deionizing air is blown onto at least one surface of said article before said examining.

5. The method according to claim 1 wherein said examining comprise (a) exposing the at least one plastics article to light produced by a light source and (b) detecting fluorescent light emitted by fluorescing defects present in said article.

6. The method according to claim 5, wherein said examining further comprise
(c) determining the size and/or shape of each fluorescing defect and/or the wavelength of the fluorescent light emitted by said defect;
(d) determining the number of fluorescing defects in said plastics article.

7. The method according to claim 6, wherein said criterion specifies a maximum size and/or a maximum number of fluorescent defects per said article.

8. The method according to claim 5 further comprising (b1) localizing the defects (determination of the position of the defects).

9. The method according to claim 8, wherein said criterion specifies a minimum distance between two fluorescing defects.

10. The method according to claim 5 wherein said examining is by image processing to distinguish between fluorescing defects and dust particles, on the basis of shape and/or size and/or position and/or wavelength of the emitted fluorescent light.

11. The method according to claim 5 wherein the light source produces light in the blue wavelength range and/or in the ultraviolet wavelength range (UV light).

12. The method according to claim 1 wherein the defects are gel particles.

13. The method according to claim 1 wherein the defects are at least one member selected from the group consisting of streaks, pinholes, glass fibers and air inclusions.

14. A device for determining the quality of a batch of granules of transparent polymeric material, comprising:
(i) means for producing at least one article from a sample of granules;
(ii) optical means for examining said article for defects;
(iii) means for quantifying the defects to obtain at least one numerical parameter and comparing said parameter to a corresponding predetermined quality acceptance criterion.

15. The device according to claim 14 wherein said means for producing comprise an injection-molding machine.

16. The device according to claim 14 further comprising means for producing deionizing air means for blowing the same onto at least a portion of the surface of said article.

17. The device according to claim 15 wherein the injection-molding machine includes a film gating system, a cooling stretch and a die.
